(19) United States
(12) Patent Application Publication
(10) Pub. No.: US 2007/0210043 A1
(43) Pub. Date: Sep. 13, 2007

(54) Method of preparing upholstery for installation on an article of furniture

(76) Inventor: John J. Mastin, Naples, FL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/520,535

(22) Filed: Sep. 13, 2006

Related U.S. Application Data
(60) Provisional application No. 60/716,643, filed on Sep. 13, 2005.

(51) Int. Cl. B23K 26/00

(52) U.S. Cl. 219/121.69

(57) ABSTRACT

A method of preparing upholstery for installation on an article of furniture having a plurality of panel surfaces, and resultant articles, are provided. The method comprises receiving a single-source of fabric; cutting said sheet into a plurality of cut fabric pieces shaped to cover the panel surfaces; and modifying at least one of the cut fabric pieces by imparting a pattern onto said piece. Methods of reducing wasted fabric in the processing of upholstery for installation on an article of furniture are also provided.

### CROSS-REFERENCE TO RELATED APPLICATIONS

This application claims priority based on U.S. Provisional Patent Application No. 60/716,643, filed Sep. 13, 2005, which is hereby incorporated by reference in full.

### BACKGROUND

An article of upholstered furniture may comprise multiple panels, wherein a first set of panels comprises a fabric of one design and a second set of panels of another design. For example, an automobile seat may have a first panel covering an outer portion of a back rest, a second panel covering an inner portion of a back rest, a third panel covering a seating area, a fourth panel covering less visible side areas, and a fifth panel covering a head rest. For design purposes, one or more of the five panels might have a design or appearance that is different from one or more of the other panels. For example, the first panel and the fourth panel might comprise a fabric that has a smooth texture with a simple pattern, while the second, third and fifth panels comprise a fabric that has a complex pattern and a texture different from the smooth texture.

Methods for preparing upholstery having multiple panels, as described above, are known. Prior art methods for preparing upholstery comprise in one step, receiving a first source sheet or roll of fabric having a (plain or pre-printed or the like) final design or texture imparted thereon, then using industry standard equipment to cut that sheet of fabric for only those panels that are intended to show the design or texture of the first source sheet or roll after installation on an article of furniture. In a second step, a second source sheet or roll of fabric having a (plain or pre-printed or the like) final design or texture imparted thereon is received and cut for only those panels that are intended to show the design or texture of the second source sheet or roll. For each additional panel having a different final design or texture (plain or pre-printed or the like), an additional source sheet or roll of fabric is needed bearing the different final design or texture.

The prior art methods have certain limitations. For example, in a case where a first panel and a second panel are to have different designs, patterns or textures, the first panel and second panel must be cut from different source sheets or rolls bearing those designs, patterns or textures. This could cause an excess of waste material. For example, if the first panel has shape one and the second panel has shape two such that shape one and shape two are different from one another, but also complimentary such that they can be arranged together on a single source sheet to minimize wasted material, using the prior art method, the panels having the complimentary shapes must nevertheless be cut from different source sheets or rolls of fabric.

Additionally, because the prior art methods require different source sheets or rolls for panels having different designs or textures, color match between source sheets or rolls may not always be optimal. Further, if the different source sheets or rolls originate from different fabric manufacturers, increased coordination of vendors is required for timely and efficient preparation of upholstery for installation on an article of furniture, such as home and office chairs and sofas, automobile bucket seats, automobile bench seats, bus seats, airplane seats, boat seats and the like, all considered herein to be articles of furniture.

### SUMMARY

A method of preparing upholstery for installation on an article of furniture is provided that addresses limitations of the prior art methods. Specifically, a method of preparing upholstery for installation on an article of furniture having a plurality of panel surfaces is provided which includes the steps of receiving a single source of fabric, then cutting said fabric into a plurality of cut fabric pieces shaped to cover the panel surfaces; and then modifying at least one of the cut fabric pieces by imparting a pattern thereon.

The methods of the present invention can provide several advantages, in the pre-production stage, the production stage, and the post-production stage of preparing upholstery for installation on an article of furniture. For designers in the pre-production stage, a broader class of patterns and designs are available for a single-source fabric than were available before without reaching into multiple sources of fabric. Plus, color match is more assured using a single-source fabric. Additionally, pattern localization is easier to achieve on cut fabric pieces, and pattern registration will be more exact. Also, flexibility for designers, product planners, engineers, production planners and managers is increased because designs can be changed later-in-time because patterns are not imparted onto fabric until source fabric has been cut into a plurality of cut fabric pieces. Moreover, when using certain laser etching, embossing or debossing techniques, turn-around time on sample patterns is much faster, allowing designers to change patterns more readily and closer-in-time to production.

Cost savings can be achieved in the pre-production stage because plain base fabrics may be less expensive to procure than pre-designed fabrics. Also, if ordering a higher volume of a single fabric, volume discounts from fabric manufacturers and distributors may be negotiated. Additionally, because plain base fabrics are so well known and understood by those of skill in the art, it may be easier and quicker, thus less costly, to perform functional testing and to meet validation requirements.

Cost savings can also be achieved during production. As noted above, the methods disclosed herein can reduce waste fabric, improving cutting yields during production. Tooling may be reduced using a single source of fabric. Fabric management issues can be simplified, and therefore less expensive, too. For example, fewer part numbers are required in the assembly of upholstery. Less coordination is required among domestic and foreign fabric vendors that could potentially hold up production. Also, with single-sourced fabric, less inventory may be required to be on-site, thereby reducing storage expenses, freight costs, and the like.

Cost savings can also be achieved post-production. Using prior art methods, inventories of a pre-designed fabric would have to be discarded when the pre-designed fabric became obsolete. In contrast, using the methods disclosed herein, a different, updated pattern can be imparted onto the same source fabric that was used as a base for an out-dated pattern. Thus, using the disclosed methods, existing inventories of fabric need not be discarded, thereby providing post-production savings. Additionally, it is believed that base fabrics tend to have a longer life than pre-designed or pre-printed fabrics, providing post-production savings to a purchaser of an article of furniture.

### BRIEF DESCRIPTION OF THE DRAWINGS

FIG. 1 is a seat having an upholstery cover, the cover comprising a plurality of panels having a first pattern, and a plurality of panels having a second pattern.

FIG. 2 is a flow chart showing an improved method for preparing upholstery for installation on an article of furniture.

FIG. 3 shows two separate sheets of fabric used to cut out panels having two different patterns for eventual installation on an article of furniture, illustrating the prior art method.

FIG. 4 shows a single source of fabric used to cut out panels having two different patterns for eventual installation on an article of furniture in accordance with the present invention.

FIG. 5 shows shaped pieces of fabric, cut from the same sheet of fabric, having different patterns imparted thereon.

### DETAILED DESCRIPTION OF THE DRAWINGS

### Definitions

“Article of furniture,” as used herein, refers broadly, without limitation, to seats, loveseats, couches, head rests, stools, ottomans, benches, panels of walls intended to be covered with fabric such as might be found in office cubicle dividers and in interiors of automobiles, boats, buses, trains and the like. The article of furniture can be intended for use in a home, an office, or on a vehicle of transportation such as a car, truck, boat, bus, train or the like.

“Fabric,” as used herein, refers broadly, without limitation, to knitted, woven or non-woven material, or combinations thereof. Fabric may be synthetic, natural or a synthetic/natural blend. Fabric is intended to include leather from animal hides, and natural and synthetic suede. Fabric may be vinyl or polyurethane or the like, or coated with vinyl, polyurethane, or the like. Source fabric can be provided as a flat sheet, as a roll, an animal hide, or in any other form known in the art.

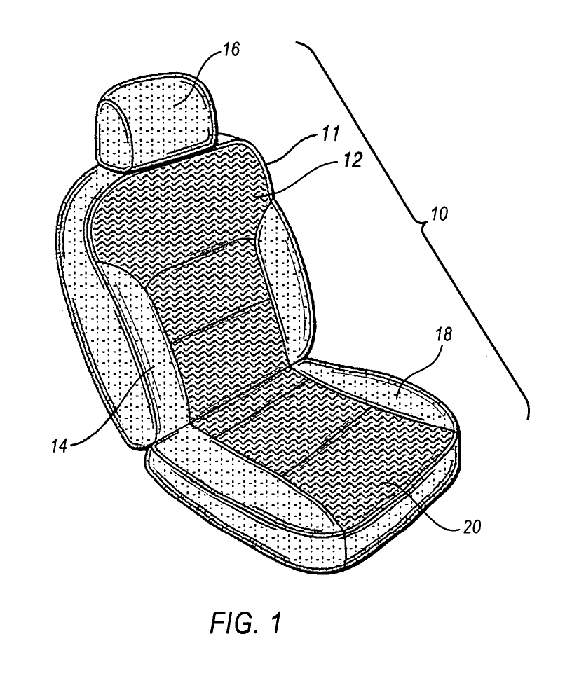

FIG. 1 shows a seat 10 having an upholstery cover 11. Cover 11 comprises a plurality of panels having a first pattern, such as panels 14, 16, and 18. Cover 11 comprises a plurality of panels having a second pattern, such as panels 12 and 20. Panels of upholstery can be comprised of any fabric suitable for use on an article of furniture such as seat 10.

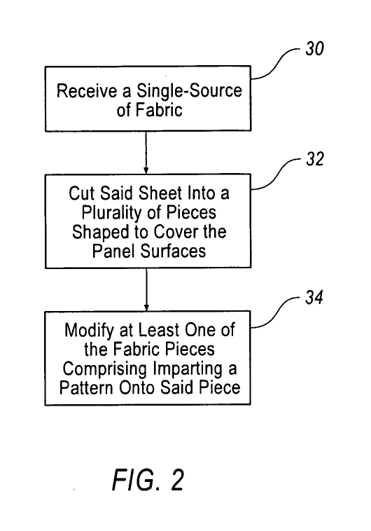

FIG. 2 is a flow chart showing an improved method for preparing upholstery for installation on an article of furniture. In receiving step 30, a singe-source of fabric is received and installed on or in whatever equipment that a vendor uses to cut the fabric into desired shapes. In cutting step 32, the single-source of fabric is cut into the desired shapes. The cutting step can be executed using any methods, software and commercially available machines that are known in the art. This includes, without limitation, blade-cutting, die-cutting, laser-cutting and robotic cutting. Gerber Technologies, Inc. of Tolland, Conn. offers a number of suitable fabric cutting solutions.

Once the fabric is cut into desired shaped pieces, some or all of the shaped pieces are modified by having a pattern imparted thereon in modification step 34. Thereafter, modified and unmodified pieces may be used together to upholster an article of furniture, as illustrated in FIG. 1. Any methods, software and machinery known in the art to impart a pattern on fabric may be used. Suitable methods, software and machinery include, without limitation, imparting patterns and/or textures through well-known pressing techniques and well-known printing techniques. Pressing techniques include, without limitation, such as embossing, debossing, and/or carving. See, for example, U.S. Pat. No. 4,199,390 “Embossing and laminating process” and U.S. Pat. No. 6,376,041 “Embossed fabric,” the disclosure of each of which is herein incorporated by reference in its entirety. Additionally, decorative or functional contours, lifts, and embossments may be imparted onto fabric pieces using dielectric embossing and other methods disclosed in U.S. Pat. No. 4,541,885 “Method of manufacturing a vehicle seat cover,” the disclosure of which is incorporated by reference in its entirety.

Pressing techniques can also be used for the creation of insignias. See, for example, U.S. Pat. No. 5,143,672 “Method for forming emblem of thermoplastic synthetic resin film,” U.S. Pat. No. 5,834,037 “Apparatus for making insignias with raised designs” and U.S. Pat. No. 6,309,582 “Method for making insignias with raised designs including two pressing steps,” the disclosure of each of which is incorporated by reference in its entirety.

Pressing techniques can also include full or partial perforation of fabric, especially with leather and leather-like synthetic materials. Patterns created by full or partial perforation of fabric are especially desirable for use for heated automobile seats having a leather upholstery cover or a leather-like synthetic upholstery cover, or a combination thereof.

Although these pressing techniques do not add ink or other colorants to fabric, these methods often impart a pattern and/or texture onto a fabric in such a way that the fabric appears to have had some of its color modified. See, for example, U.S. Pat. No. 4,588,629 “Embossed fabrics to give contrasting colors,” the disclosure of which is herein incorporated by reference in its entirety.

Printing techniques include, without limitation, photographic printing technology, transfer print or deposit print technology, digital printing technology, and chemical and/or laser etching. See, for example, U.S. Pat. Nos. 6,467,898 and 6,702,438, each of which is titled “Method and apparatus for ink jet printing on textiles” and the disclosures of each of which is herein incorporated by reference in its entirety. Many printing techniques require the addition of a dye or an ink to the fabric to impart a pattern. As is well known in the art, particular dyes and inks should be selected to minimize rub-off effects for use with the methods in the present invention.

Particularly preferred methods and techniques and apparatuses for imparting patterns onto cut pieces of fabric include those disclosed in a series of patents issued to Dr. Darryl Costin, the disclosures of each of which is incorporated by reference herein in its entirety: U.S. Pat. No. 6,858,815 “Denim designs from laser scribing”; U.S. Pat. No. 6,819,972 “Material surface processing with a laser that has a scan modulated effective power to achieve multiple worn looks”; U.S. Pat. No. 6,807,456 “Fractal jean manufacturing”; U.S. Pat. No. 6,753,501 “Processing of textile materials using laser beams and material sized in larger widths”; U.S. Pat. No. 6,685,868 “Laser method of scribing graphics”; U.S. Pat. No. 6,664,204 “Solar inhibiting glasses with increased redox and iron”; U.S. Pat. No. 6,616,710 “Laser scribing process to eliminate the denim enzyme by washing and laundry”; U.S. Pat. No. 6,576,862 “Laser-scribing process for rubber and thermoplastic materials such as a hose”; U.S. Pat. No. 6,495,237 “Denim design from laser scribing U.S. Pat. No. 6,315,202 Material coding using lasers”; U.S. Pat. No. 6,252,196 “Laser method of scribing graphics”; U.S. Pat. No. 6,178,413 “Database program with automatic creation of user features”; U.S. Pat. No. 6,140,602 “Marking of fabrics and other materials using a laser”; U.S. Pat. No. 6,002,099 “User control interface for laser simulating sandblasting apparatus”; U.S. Pat. No. 5,990,444 “Laser method and system of scribing graphics”; U.S. Pat. No. 5,916,461 “System and method for processing surfaces by a laser.”

Although FIG. 2 includes only these three steps of preparing fabric, users of the methods of the present invention may include optional additional steps, such as adding sunscreen compounds, stain resistant compounds, and other compounds to the cut pieces of fabric. Additionally, steps are also contemplated wherein cut pieces of fabric are attached to one another to take the shape of an article of furniture for installation on the article of furniture. Any method of attachment known in the art is acceptable, including sewing, stapling, the use of adhesives, heat fusion, and others. These steps may be manual or automated.

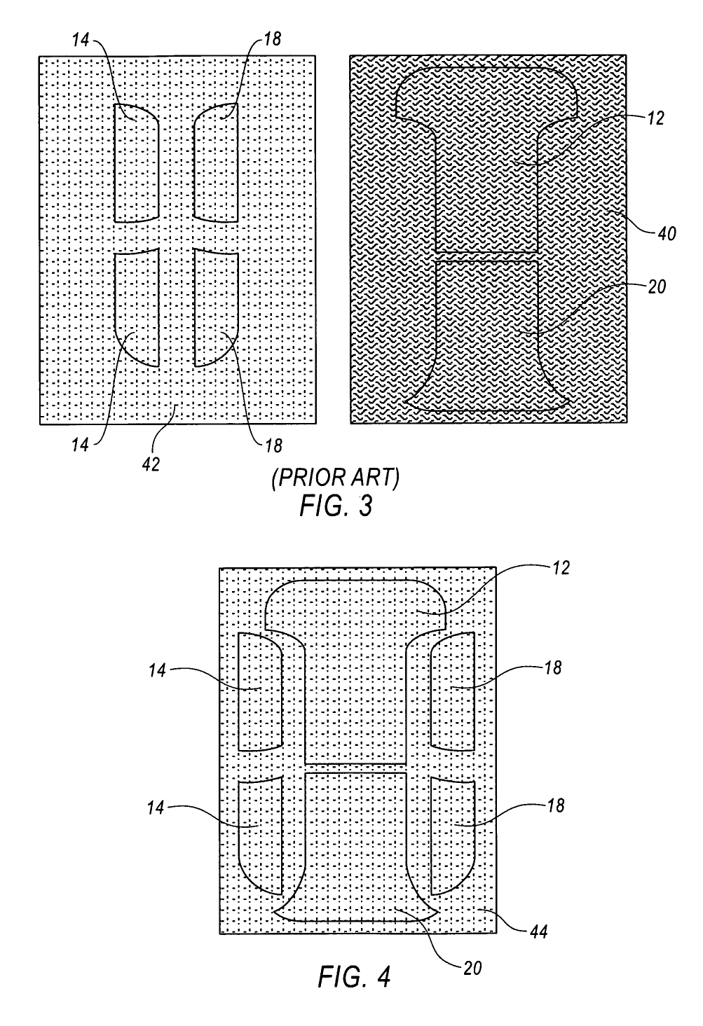

FIG. 3 illustrates the prior art. It shows two separate source sheets of fabric used to cut out panels having two different patterns for eventual installation on an article of furniture, such as seat 10 in FIG. 1. FIG. 3 graphically displays the limitations of the prior art methodology. In particular, because panels 14 and 18 having a first pattern must be cut from a different feed sheet or feed roll from panels 12 and 20, having a second pattern different from the first pattern, a large amount of wasted fabric 40 and 42 results.

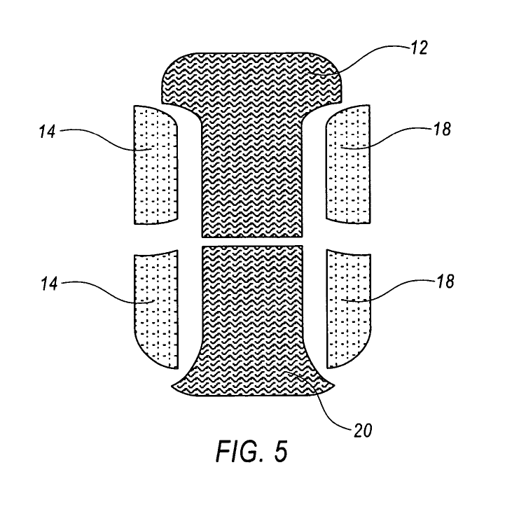

FIGS. 4 and 5 show how the methods of the present invention reduce the large amount of wasted fabric 40 and 42. FIG. 4. shows that, even though panels 12 and 20 will ultimately have a pattern that is different from the pattern of panels 14 and 18, as shown in FIG. 1, panels 12, 14, 18 and 20 can all be cut from the same source of fabric. This allows for an arrangement of shapes (e.g., ganging of dies) to minimize wasted fabric 44. Then, after panels 12, 14, 18 and 20 are cut, panels 12 and 20 undergo additional processing whereby a pattern is imparted onto panels 12 and 20. The additional processing can be embossing, debossing, laser printing, laser etching, transfer printing, or any other processing known in the art to impart a pattern onto fabric. The additional processing results in FIG. 5.

Once a plurality of panels have been cut and modified, the plurality can be attached to form a cover for an article of furniture, such as seat cover 11, as shown in FIG. 1. The method of attachment can be any method known in the art, including but not limited to sewing, stapling, the use of adhesives, heat fusion, and others. These steps may be manual or automated. The formed cover may then be installed on an article of furniture using any method known in the art.

The above-described embodiments describe but one application of the invention. It will be understood by those who practice the invention and those skilled in the art that various modifications and improvements may be made to the invention without departing from the spirit of the disclosed concept. The scope of the protection afforded is to be determined by the appended claims and by the breadth of interpretation allowed by law.

1. A method of preparing upholstery for installation on an article of furniture having a plurality of panel surfaces comprising:
(a) receiving a single-source of fabric;
(b) cutting said sheet into a plurality of cut fabric pieces shaped to cover the panel surfaces; and
(c) modifying at least one of the cut fabric pieces by imparting a pattern onto said piece.

2. The method of claim 1 wherein the source of fabric is a roll of fabric.

3. The method of claim 1 wherein the pattern is imparted by a method selected from the group consisting of pressing and printing.

4. The method of claim 1 wherein the pattern is imparted by a method selected from the group consisting of embossing, debossing, carving, and combinations thereof.

5. A method of preparing upholstery for installation on a seat in an automobile, the seat having a plurality of panel surfaces comprising:
(a) receiving a single-source of fabric;
(b) cutting said sheet into a plurality of cut fabric pieces shaped to cover the panel surfaces; and
(c) modifying at least one of the cut fabric pieces by imparting a pattern onto said piece.

6. The method of claim 5 further comprising a step following step (c):
(d) attaching the plurality of cut fabric pieces to form a seat cover.

7. The method of claim 6 wherein the plurality of cut fabric pieces are attached by sewing.

8. An upholstery cover prepared by the method of claim 6.

9. An automobile comprising a seat covered with the upholstery cover of claim 8.

10. The method of claim 5 wherein the pattern is imparted by a method selected from the group consisting of embossing, debossing, carving and combinations thereof.

11. A method of reducing wasted fabric in the processing of upholstery for installation on an article of furniture, comprising:
(a) receiving a single-source of fabric;
(b) positioning a plurality of shapes, the shapes to have a plurality of patterns after installation on the article of furniture, such that the plurality of shapes can be cut from the single source of fabric to minimize wasted fabric;
(c) cutting said sheet into a plurality of cut fabric pieces shaped to cover the panel surfaces;
(d) modifying at least one of the cut fabric pieces by imparting a pattern onto said piece; and
(e) attaching the plurality of cut fabric pieces to form an upholstery cover fitted to the article of furniture.

12. The method of claim 11 wherein the source of fabric is a roll of fabric.

13. The method of claim 11 wherein the source of fabric is selected from the group consisting of a sheet and an animal hide.

14. The method of claim 11 wherein the pattern is imparted by a method selected from the group consisting of embossing, debossing, laser etching and combinations thereof.

15. The method of claim 11 wherein the pattern is imparted by printing.

16. The method of claim 11 wherein the pattern is imparted by a method selected from the group consisting of laser etching and chemical etching.

17. The method of claim 11 wherein the article of furniture is an automobile seat.

18. The method of claim 11 wherein the upholstery cover is an automobile seat cover.

19. An automobile seat cover prepared by the method of claim 18.

20. An automobile comprising a seat covered with the seat cover of claim 19.
